(19) United States
(12) Patent Application Publication
(10) Pub. No.: US 2025/0390272 A1
(43) Pub. Date: Dec. 25, 2025

(54) MUSIC DISTRIBUTION SYSTEM, PROGRAM AND SERVER

(71) Applicant: Fillgoo Co., Ltd., Shibuya-ku, Tokyo (JP)

(72) Inventor: Yoshikazu GROVER, Meguro-ku, Tokyo (JP)

(73) Assignee: Fillgoo Co., Ltd., Shibuya-ku, Tokyo (JP)

(21) Appl. No.: 18/993,143

(22) PCT Filed: Jul. 12, 2023
(86) PCT No.: PCT/JP2023/025790

§ 371 Date: Jan. 10, 2025

(30) Foreign Application Priority Data
Jul. 12, 2022 (JP) 2022-112017

(51) Int. Cl. G06F 3/16; G06V 10/764; G06V 40/16

(52) U.S. Cl. CPC G06F 3/165; G06V 10/764; G06V 40/174

(57) ABSTRACT

A music distribution system 1 comprising a plurality of terminal apparatus 10 each used by a plurality of users and a server 20 configured to communicate with the plurality of terminal apparatus 10, wherein the server 20 stores a plurality of song lists each corresponding to a plurality of classifications of human emotions in a memory 22, each terminal apparatus 10generates a user image by photographing a user of its own apparatus, server 20 acquires, for each terminal apparatus 10, a classification of a user's emotion estimated from the user image to select a song included in the song list corresponding to the classification as a first song, and each terminal apparatus 10 plays the first song selected for its own apparatus.

### CROSS-REFERENCE TO RELATED APPLICATION

This application claims priority to Japanese Patent Application No. 2022-112017 filed on Jul. 12, 2022, the entire contents of which are incorporated herein by reference.

### TECHNICAL FIELD

The present disclosure relates to music distribution systems, programs and servers.

### BACKGROUND

Conventional technology for distributing song to users' terminal apparatus is known. For example, Patent Document 1 discloses a music distribution system with still pictures that distributes server music data and still picture data from a server to a mobile terminal.

### CITATION LIST

### Patent Literature

PTL 1: JP 2002-287772 A

### SUMMARY

### Technical Problem

Since the song that is comfortable for the user can change depending on the user's emotions (mood) when listening to the song, it is desirable to deliver appropriate song according to the user's emotions. Therefore, there was room for improvement in the technology for delivering songs to users' terminal apparatus.

The purpose of the present disclosure, made in view of such circumstances, is to improve the technology for delivering songs to users' terminal apparatus.

### Solution to Problem

A music distribution system according to an embodiment of the present disclosure is a music distribution system including a plurality of terminal apparatus each used by a plurality of users and a server configured to communicate with the plurality of terminal apparatus, wherein
the server is configured to store in its memory a plurality of song lists each corresponding to a plurality of classifications of human emotions,
each terminal apparatus is configured to generate a user image by photographing a user of its own apparatus,
the server is configured to acquire, for each terminal apparatus, a classification of a user's emotion estimated from the user image to select a song in the song list corresponding to the classification as a first song, and
each terminal apparatus is configured to play the first song selected for its own apparatus.

A program according to an embodiment of the present disclosure is configured to cause a server capable of communicating with a plurality of terminal apparatus used respectively by a plurality of users to execute operations, the operations including:
storing in its memory a plurality of song lists corresponding respectively to a plurality of classifications of human emotions;
acquiring, for each terminal apparatus, a classification of a user's emotion estimated from a user image generated by the terminal apparatus by photographing a user of its own apparatus to select a song in the song list corresponding to the classification as a first song; and
distributing, for each terminal apparatus, the first song to the terminal apparatus.

A server according to an embodiment of the present disclosure includes:
a communication interface configured to communicate with a plurality of terminal apparatus each used by a plurality of users;
a memory configured to store a plurality of song lists each corresponding to a plurality of classifications of human emotions; and
a controller configured to acquire, for each terminal apparatus, a classification of a user's emotion estimated from a user image generated by the terminal apparatus by photographing a user of its own apparatus to select a song in the song list corresponding to the classification as a first song, and distribute the first song to the terminal apparatus.

### Advantageous Effect

According to one embodiment of the present disclosure, the technology for distributing songs to a user's terminal apparatus is improved.

### BRIEF DESCRIPTION OF THE DRAWINGS

In the accompanying drawings:

FIG. 1 is a block diagram illustrating a schematic configuration of a music distribution system according to an embodiment of the present disclosure;

FIG. 2 is a block diagram illustrating a schematic configuration of a terminal apparatus;

FIG. 3 is a block diagram illustrating a schematic configuration of a server;

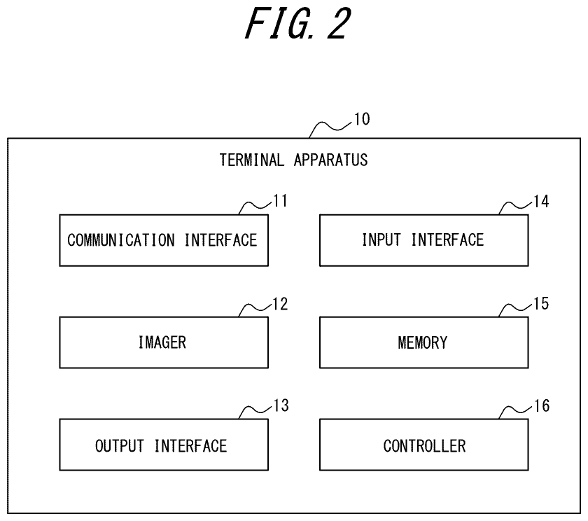

FIG. 2 is a sequence diagram illustrating an example of operations of the music distribution system;

FIG. 5 is a schematic diagram illustrating an example of information stored by the server;

FIG. 6 is a schematic diagram illustrating an example of information stored by the server;

FIG. 7 is a schematic diagram illustrating an example of information stored by the server; and

FIG. 8 is a schematic diagram illustrating an example of information stored by the server.

### DETAILED DESCRIPTION

Hereinafter, an embodiment of the present disclosure will be described.

### Outline of Embodiment

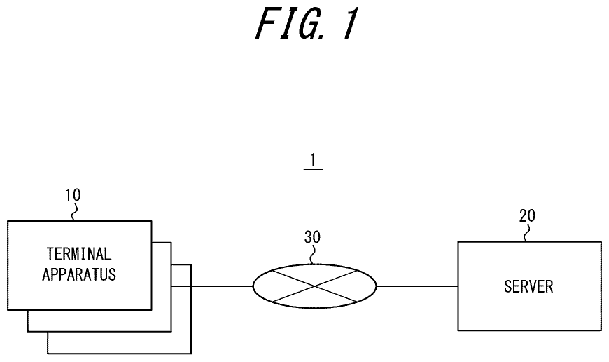

An outline of a music distribution system 1 according to the embodiment of the present disclosure will be described with reference to FIG. 1. The music distribution system 1 includes a plurality of terminal apparatuses 10 and a server 20. The terminal apparatus 10 and the server 20 can communicate with each other via a network 30 including, for example, the Internet and a mobile communication network.

The terminal apparatus 10 is a computer, such as a personal computer (PC), a smartphone, or a tablet terminal, for example. In the present embodiment, each of the multiple terminal apparatus 10 is used by multiple users. In one example, a user can start an application program installed on the terminal apparatus 10 and receive music distribution via said application program.

Server 20 comprises one or more server apparatus. In the present embodiment, server 20 is used to provide a music distribution service that distributes song to terminal apparatus 10 via network 30.

First, an outline of the present embodiment will be described, and details thereof will be described later. In the song distribution system 1, the server 20 stores a plurality of song lists, each corresponding to a plurality of categories of human emotions (moods) (e.g., “joy,” “anger,” and “sadness”). Each terminal apparatus 10 takes a picture of the face of the user of its own apparatus and generates a face image. Server 20 obtains the classification of the user's emotion estimated from said facial image for each terminal apparatus 10 (for each user), and selects the song included in the song list corresponding to said classification as the first song. Each terminal apparatus 10 then plays the selected first song for its own apparatus.

According to the present embodiment, the first song to be delivered to the user is selected from among a plurality of song lists, from the song list corresponding to the classification of the user's emotion estimated from the user's facial image. For example, if the user's emotion category estimated from the facial image is “joy”, the first song is selected from the song list corresponding to “joy”. Therefore, by having a song appropriate according to a classification of human emotion (e.g., a song that is likely to be pleasant when viewed by a person having the emotion of “joy”) included in a list of songs corresponding to said classification, the technology for delivering a song as the first song is improved in that a song appropriate according to the user's emotion is delivered as the first song, and the user's This improves the technology for delivering songs to the terminal apparatus 10.

Next, configurations of the music distribution system 1 will be described in detail.

### Configuration of Terminal Apparatus

As illustrated in FIG. 2, the terminal apparatus 10 includes a communication interface 11, an imager 12, an output interface 13, an input interface 14, a memory 15, and a controller 16.

The communication interface 11 includes at least one communication interface for connecting to the network. The communication interface may be compliant with, for example, mobile communication standards, wired local area network (LAN) standards, or wireless LAN standards, but these examples are not limiting. The communication interface may be compliant with any appropriate communication standards.

The imager 12 is equipped with one or more cameras. In the present embodiment, the imager 12 is used to capture the user's face and generate a face image.

The output interface 13 includes at least one output device for outputting information. The output device is, for example, a display for outputting information as video, a speaker for outputting information as audio, or the like, but is not limited to these. Alternatively, the output interface 13 may include an interface for connecting to an external output device.

The input interface 14 includes at least one input device for detecting user input. The input device is, for example, a physical key, a capacitive key, a mouse, a touch panel, a touch screen integrally provided with a display of the output interface 13, a microphone, or the like, but is not limited to these. Alternatively, the input interface 14 may include an interface for connecting to an external input device.

The memory 15 includes one or more memories. The memories are, for example, semiconductor memories, magnetic memories, optical memories, or the like, but are not limited to these. The memories included in the memory 15 may each function as, for example, a main memory, an auxiliary memory, or a cache memory. The memory 15 stores any information to be used for operations of the terminal apparatus 10. For example, the memory 15 may store a system program, an application program, embedded software, and the like.

The controller 16 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 16 controls the operations of the entire corresponding terminal apparatus 10.

The terminal apparatus 10 may be further equipped with components not mentioned above. For example, terminal apparatus 10 may be further equipped with a satellite positioning system receiver such as GPS (Global Positioning System) to obtain location information of its own apparatus (user).

### Configuration of Server

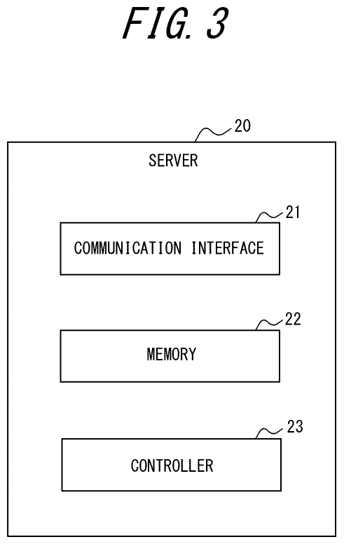

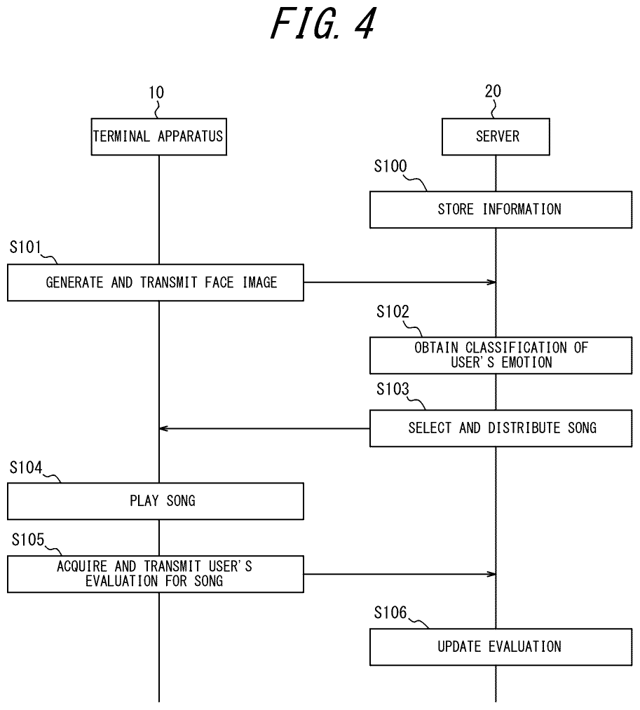

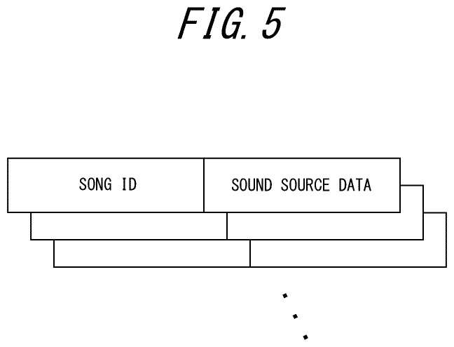

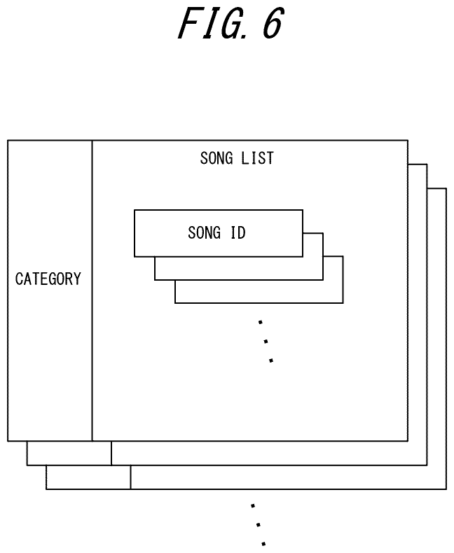

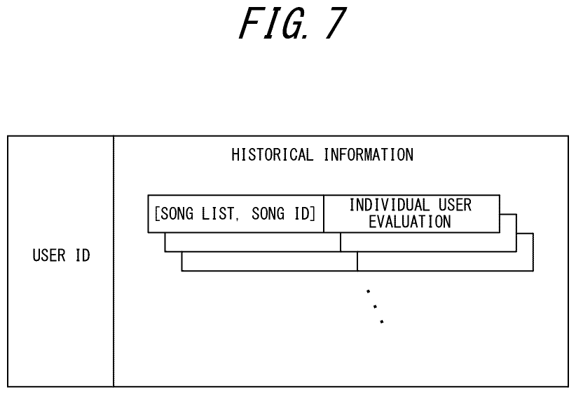

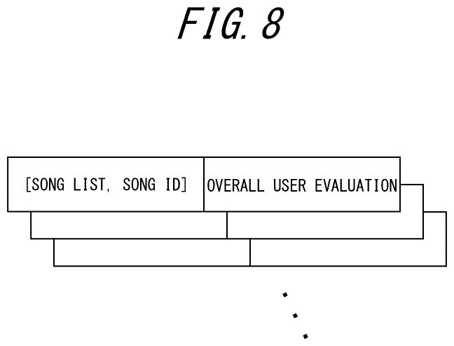

As illustrated in FIG. 3, the server 20 includes a communication interface 21, a memory 22, and a controller 23.

The communication interface 21 includes at least one communication interface for connecting to the network 30. The communication interface is compliant with a wired LAN standard or a wireless LAN standard, for example, but is not limited to these, and may be compliant with any communication standard.

The memory 22 includes one or more memories. The memories included in the memory 22 may each function as, for example, a main memory, an auxiliary memory, or a cache memory. The memory 22 stores any information to be used for operations of the server 20. For example, the memory 22 may store a system program, an application program, embedded software, a database, and the like.

The controller 23 includes at least one processor, at least one programmable circuit, at least one dedicated circuit, or a combination of these. The controller 23 controls the operations of the entire server 20.

### Operation of the Music Distribution System

Next, operations of the music distribution system 1 will be described with reference to FIG. 4. This operation can be performed for individual terminal apparatus 10. In outline, this operation is to distribute a song to a user of terminal apparatus 10, and to acquire and collect the user's evaluation of the song.

Step S100: The controller 23 of the server 20 stores the information used to provide the music distribution service in the memory 22.

Specific examples of information stored in memory 22 are described here with reference to FIG. 5 and FIG. 6.

For example, the controller 23 stores a plurality of songs in the memory 22 for distribution to users. In detail, controller 23 stores sound source data in memory 22 for each song, as shown in FIG. 5, by associating it with a song ID. The song ID is an identifier that uniquely indicates a song in the music distribution system 1. Sound source data is an audio file in any format, for example, WAV format or MP3.

In the present embodiment, the song stored in memory 22 includes classical song. Alternatively, all the song stored in memory 22 may be classical song. However, it is not limited to classical song, and song of any genre, such as jazz song, for example, may be stored in the memory 22.

It is also generally believed that song played on instruments whose standard pitch is tuned to 432 Hz has a healing effect. In the present embodiment, the song stored in memory 22 includes song that is recorded as performed by an instrument whose standard pitch is tuned to 432 Hz. Alternatively, all songs stored in memory 22 may be recorded performances by instruments whose standard pitch is tuned to 432 Hz.

For example, controller 23 stores in memory 22 a plurality of song lists, each corresponding to a plurality of categories of human emotions, as shown in FIG. 6. In other words, there is a one-to-one correspondence between the classification of human emotions and the list of songs. Categories of human emotions may include, but are not limited to, for example, “joy,” “anger,” and “sadness. A song list is a list containing one or more song IDs. A single song ID may be included in each of multiple song lists with different corresponding classifications. In the present embodiment, the song ID of each song appropriate to the classification of human emotion is included in the song list corresponding to that classification. Here, “song appropriate for the classification of human emotions” is song that is likely to be pleasant when viewed by a person with the relevant emotional classification, and can be selected using empirical methods or statistical methods based on field surveys, for example.

It is not necessary that all songs stored in memory 22 are included in any of the song lists. In other words, some songs stored in memory 22 may not be included in any song list.

Step S101: The controller 16 of the terminal apparatus 10 takes a picture of the face of the user of its own apparatus using the imager 12 to generate a face image, and transmits said face image to the server 20 via the communication interface 11.

Specifically, controller 16 starts an application program dedicated to the music distribution service. In accordance with said application program, the controller 16 prompts the user to take a picture of his/her face after successfully completing the prescribed login process using, for example, a user ID and password. The prescribed login process may be performed using, for example, a user ID and password, but may be performed using any method. For example, the login process may be performed using a phone number or by linking an account with an existing web service. When the controller 16 generates a face image of the user using the imager 12, it transmits said face image to the server 20. Thus, in the present embodiment, the face image is generated after the application program is started and before the song is played.

Step S102: The controller 23 of server 20 obtains the classification of the user's emotion estimated from the face image in step S101.

The classification of user emotions can be estimated by any method. For example, a method using an emotion estimation AI that takes a human face image as input and outputs a classification of said human emotion. The estimation of the classification of the user's emotion using the emotion estimation AI may be performed by the controller 23 or by an external server with which the server 20 can communicate via network 30.

Step S103: The controller 23 of the server 20 selects a song for the song list corresponding to the classification obtained in step S102 and distributes the song to the terminal apparatus 10 via the communication interface 21.

In the present embodiment, any of the songs included in the song list corresponding to the classification obtained in step S102 is selected as the first song. For example, if the classification obtained in step S102 is “joy”, the first song is selected from the song list corresponding to “joy”. For the sake of simplicity of explanation, we will assume that one first of song is selected, but multiple first song may be selected.

Step S104: The controller 16 of the terminal apparatus 10 plays the song selected and distributed in step S103 (i.e., the song selected for its own apparatus).

In the present embodiment, controller 16 plays the first song selected and distributed in step S103. The first song is output via the speakers of the output interface 13.

Step S105: The controller 16 of the terminal apparatus 10 acquires the user's evaluation of the song in step S104 during or after playing the song, and transmits said evaluation to the server 20 via the communication interface 11.

Any method can be employed to obtain the user's evaluation of the song. In the present embodiment, the controller 16 prompts the user to select whether or not he/she likes the song during or after playback of the song. The controller 16 determines whether the user likes the song based on the user input via the input interface 14, and obtains the result of the determination as the user's evaluation of the song. Thus, in the present embodiment, the user's evaluation of a song is obtained in two steps, but it may be obtained in n steps (n is a natural number greater than or equal to 3).

Step S106: The controller 23 of the server 20 stores or updates the evaluations for the song based on the evaluations in step S105.

In the present embodiment, when the controller 23 receives a user's evaluation of a song from the terminal apparatus 10, it stores or updates two types of evaluations, individual user evaluation and overall user evaluation, in the memory 22. In outline, the two differ in that individual user evaluations are made by individual users, whereas overall user evaluations are made by one or more users.

First, individual user evaluation is explained. The controller 23 stores the historical information in the memory 22 in association with the user ID of the user, or updates the said historical information already stored in the memory 22, as shown in FIG. 7, for example. The historical information includes individual user evaluations for each combination of song list and song ID.

Here, as mentioned above, the song that feels comfortable to the user can change depending on the user's emotions when viewing the song. In other words, the user's evaluation of a certain song can vary depending on the user's emotions at the time of viewing. In the present embodiment, therefore, the controller 23 is associated with the combination of the song list of step S103 (i.e., the song list corresponding to the classification obtained in step S102) and the song ID of the song selected for that song list (here, the first song selected from within that song list), The evaluation received from terminal apparatus 10 is stored in the memory 22 as an individual user evaluation, or the individual user evaluation already stored for the combination is updated. For example, if “Song A1” was selected as the first song from “Song List A” in step S103, the individual user evaluation corresponding to the combination of “Song List A” and “Song ID of Song A1” is stored or updated. According to such a configuration, it is possible to store more accurate evaluations that reflect the user's emotions when listening to a song, compared to a configuration that stores user evaluations associated only with song IDs, for example.

Updating the individual user evaluation may be performed by overwriting the individual user evaluation with the evaluation in step S105, or by increasing or decreasing the individual user evaluation by converting the evaluation in step S105 into a score.

This section describes the uses of individual user evaluations. For example, the controller 23 may, in step S103 described above, when selecting a song for the song list corresponding to the classification of the user's emotion the present embodiment, when selecting the first song from said song list), not select a song for which the individual user evaluation associated with said song list is lower than the predetermined standard. The song may be selected in such a way that the individual user evaluation associated with the song list is lower than the predetermined standard. According to this configuration, the probability that a song that the user viewed and gave a low evaluation when he or she had the same emotion in the past will be distributed again to a user who has a certain emotion is reduced.

The overall user evaluation is then described. As shown in FIG. 8, for example, the controller 23, in association with the combination of the song list of step S103 (i.e., the song list corresponding to the classification obtained in step S102) and the song ID of the song selected for said song list (here, the first song selected from within said song list) The overall user evaluation is stored in the memory 22, or the overall user evaluation already stored in the memory 22 is updated. For example, if “Song A1” was selected as the first song from “Song List A” in step S103, the overall user evaluation corresponding to the combination of “Song List A” and “Song ID of Song A1” is stored or updated. According to such a configuration, it is possible to store more accurate evaluations that reflect the user's emotions when listening to a song, compared to a configuration that stores user evaluations associated only with song IDs, for example.

The updating of the overall user evaluation is performed, for example, by converting the evaluation in step S105 into a score and increasing or decreasing the overall user evaluation (e.g., the average value of the scores converted from each user's evaluation is used as the overall user evaluation).

Explain the use of the overall user evaluation. For example, the controller 23 may exclude a song ID from a certain song list if the overall user evaluation corresponding to the combination of a song list and the song ID of the first song is lower than a predetermined standard. According to such a configuration, if a song that was initially thought to have a high likelihood of being pleasant when viewed by a person with a certain category of emotion is actually judged to have a low likelihood based on the overall user evaluation, the song can be excluded from the song list in question.

As described above, according to the music distribution system 1 for the present embodiment, the server 20 stores a plurality of song lists, each corresponding to a plurality of classifications of human emotions. Each terminal apparatus 10 takes a picture of the face of the user of its own apparatus and generates a face image. Server 20 obtains the classification of the user's emotion as estimated from said facial image for each terminal apparatus 10, and selects as the first song the song included in the song list corresponding to said classification. Each terminal apparatus 10 then plays the first song selected for its own apparatus.

According to such a configuration, the first song to be delivered to the user is selected from among a plurality of song lists, from the song list corresponding to the emotional classification of the user as estimated from the user's facial image. Therefore, the technology for delivering songs to the user's terminal apparatus 10 is improved in that the appropriate song is delivered as the first song according to the user's emotion by having the appropriate song for the human emotion classification included in the song list corresponding to that classification.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or a single component, step, or the like can be divided.

For example, in the embodiment described above, when server 20 selects and distributes songs in the song list corresponding to the emotional classification of the user of terminal apparatus 10 in step S103, any of the songs in the song list corresponding to that classification is selected and distributed as the first song. However, in step S103, server 20 may select and distribute as the second song a song that is not included in the song list corresponding to the emotional classification of the user of terminal apparatus 10.

If the second song is selected and distributed in step S103, the terminal apparatus 10 plays the selected song (in this case, the second song) for its own apparatus (step S104), and during or after playing the second song, obtains the user's evaluation of the second song and transmits it to the server 20 (step S105). Server 20 then stores or updates the evaluation for that second song based on the evaluation in step S105. For example, if “Song B1” not included in “Song List A” is selected as the second song for “Song List A” corresponding to the user's emotion classification, the individual user evaluation and the overall user evaluation corresponding to the combination of “Song List A” and “Song ID of Song B1” are stored on the server 20.

Furthermore, server 20 may add the song ID to the song list if the overall user evaluation corresponding to the combination of the song IDs of a certain song list and the second song is higher than a predetermined criterion. According to such a configuration, if a song that was initially thought to have a low likelihood of being pleasant when viewed by a person with a certain category of emotion is actually determined to have a high likelihood based on the overall user evaluation, the song can be added to the relevant song list.

In the embodiment described above, the controller 23 of the server 20 may store the attributes of each song included in each song list in the memory 22 by mapping them to the song ID of the song in question. Attributes” here refers to user attributes that are generally expected to be suitable for viewing the song (excluding emotional categories), and may include, for example, “gender” (“male”, “female”, “other”, etc.), “age” (“teen”, “20s”, etc.), “hobbies” (“driving”, “cooking”, etc.), “medical history” (“healthy”, “under treatment for depression”, etc.), and “location classification” (“home”, “hospital”, “library”, etc.). Depression,” etc.), and “location classification” (“home,” “hospital,” “library,” etc.).

In such a case, the controller 16 of the terminal apparatus 10 may further acquire the user's attributes and send them to the server 20 when sending the face image to the server 20 in step S101. For example, the attributes of “gender,” “age,” “medical history,” and “hobbies” may be entered into the terminal apparatus 10 in advance by the user himself/herself using the profile setting function implemented in the application program. For example, the “classification of the location where the user is located” may be obtained by the controller 16 determining the location information of the user (own apparatus) using the satellite positioning system receiver provided in the terminal apparatus 10 and matching said location information with map information. Then, when the server 20 selects and distributes a song from the song list corresponding to the emotional category of the user of the terminal apparatus 10 in step S103, it may select as the first song a song that is included in that song list and that has the same or corresponding attributes as the user. According to such a configuration, it is possible to distribute appropriate songs as the first song according to the user's emotions and attributes.

In the embodiment described above, when the controller 23 of the server 20 stores the sound source data associated with the song ID in the memory 22 in step S100, it may further store information indicating the rights holder of the song in addition to the sound source data. In such a case, the controller 16 of the terminal apparatus 10 may transmit the playback time of the song to the server 20 when the playback of the song is finished. The controller 23 of server 20 may then acquire the playback time of the song and execute a process to grant a reward according to the playback time to the rights holder of the song.

In the embodiment described above, the process of the terminal apparatus 10 capturing the user's face and generating a face image was described (step S101). Here, the face image may be an image generated by capturing the faces of multiple users. In such a case, the controller 23 of the server 20 performs, for each of the plurality of users, the acquisition of the classification of the user's emotion (step S102), and the selection and distribution of the song from the song list corresponding to the acquired classification (step S103).

In the embodiment described above, the process of the server 20 obtaining the classification of the user's emotion estimated from the face image was described (step S102). However, it is also possible to implement a system that does not use face images to obtain a classification of the user's emotions. For example, the controller 16 of the terminal apparatus 10 may start an application program dedicated to the music distribution service and, after successfully completing the prescribed login process, prompt the user to enter the classification of the emotion at that point. In such a case, the controller 16 notifies the server 20 of the classification of the user's emotion as entered by the user. Then, the controller 23 of the server 20 obtains the classification of the user's emotion notified by the terminal apparatus 10, selects a song from the song list corresponding to the classification, and distributes the song to the terminal apparatus 10 via the communication interface 21 (step S103).

In the embodiment described above, we have also described an example in which the song stored in memory 22 includes a recorded performance by a musical instrument whose standard pitch is tuned to 432 Hz. However, the song stored in memory 22 may include song recorded performed by an instrument whose reference pitch is tuned to a frequency other than 432 Hz (e.g., 440 Hz). For example, the song stored in memory 22 may include a recording of a performance by a musical instrument in which the pitch of at least one note in the scale is tuned to a solfeggio frequency (e.g., 528 Hz).

In the embodiment described above, the controller 23 of server 20 described an example in which a plurality of song lists corresponding to each of the plurality of classifications of human emotions are stored in memory 22 (i.e., the classification of human emotions and the song lists have a one-to-one correspondence). However, it is also possible to have an implementation in which more than one song list is mapped to one classification.

For example, the song that is comfortable for the user can vary depending on the time of day when the song is viewed, as well as the user's emotions when viewing the song. Therefore, the controller 23 may store in the memory 22 a plurality of song lists with different time periods from each other for one classification. Here, “a plurality of song lists with different time zones set for each other” is, for example, five song lists with five time zones set for each of “4:00-7:00”, “7:00-12:00”, “12:00-18:00”, “18:00-23:00” and “23:00-4:00”, However, it is not limited to the said examples. In such a case, the controller 23 of the server 20 selects a song from one of the plurality of song lists corresponding to the classification obtained in step S102 above, for which a time zone to which the current time belongs is set, and distributes the song to the terminal apparatus 10 via the communication interface 21 (step S103). According to such a configuration, it is possible to distribute an appropriate song as the first song according to the user's emotion and time of day when viewing the song.

In the embodiment described above, the controller 23 of server 20 described an example of obtaining the classification of the user's emotion from the facial image of the user's face (step S102). However, an implementation that is not limited to face images, but obtains the classification of the user's emotion from any user image taken of the user, is also possible. For example, controller 23 may obtain the classification of the user's emotion from a skin image taken of the user's skin, such as the user's fingertips. In detail, the controller 23 can estimate the heart rate from the color change of the user's skin based on the skin image, and can obtain a classification of the user's emotion based on the estimated heart rate or the change in heart rate.

Alternatively, it is also possible to obtain a classification of the user's emotions without using a user image such as a face or skin image. For example, the controller 16 of the terminal apparatus 10 may generate voice data that collects the user's voice and transmit it to the server 20 in step S101 described above. The controller 23 of server 20 may then obtain the classification of the user's emotion based on the received voice data in step S102. Alternatively, the controller 16 of the terminal apparatus 10 may measure biometric data, such as body temperature, blood pressure or heart rate, and transmit the data to the server 20 in step S101 described above. The controller 23 of server 20 may then obtain a classification of the user's emotions based on the received biometric data or changes in the biometric data in step S102.

In the embodiment described above, “joy,” “anger,” and “sadness” are examples of multiple classifications of human emotions, but “multiple classifications of emotions” are not limited to these examples. For example, an implementation that employs a range of degrees of smiles or stress, etc. as “multiple categories of emotions” is also possible. For example, when the degree of smile or stress, etc. is indicated by a numerical value from 0 to 100, the first classification may be used when the range of the degree is between 0 and 30, the second classification when the range of the degree is between 30 and 70, and the third classification when the range of the degree is between 70 and 100.

In the embodiment described above, the controller 23 of the server 20 described an example of storing a plurality of song lists in the memory 22, each corresponding to a plurality of classifications of human emotions (step S100). In other words, the above mentioned embodiment describes an example in which a list of songs is stored for each “classification of human emotions”. In contrast, the controller 23 may store a list of songs in the memory 22 for each combination of four items, for example, “classification of human emotions,” “weather,” “humidity,” and “temperature. In such a case, the controller 23 may obtain “weather,” “humidity,” and “temperature” in addition to “user emotion classification” in step S102 above. The controller 23 may then select a song for the song list corresponding to the combination of “user emotion category,” “weather,” “humidity,” and “temperature” in step S103 described above, and deliver said song to the terminal apparatus 10.

In the embodiment described above, the controller 23 of server 20 described an example in which the controller 23 of server 20 obtains the classification of the user's emotion before playing the song. In contrast, the controller 23 may acquire the user's emotion classification during or after playback of the song in addition to before playback of the song. In such a case, the controller 23 may detect changes in the user's emotional classification between before and during or after playback of the song, and store information indicating such changes (i.e., information indicating how the emotional classification has changed) in the memory 22 tied to the song. For example, if the user's emotional category changes from “sadness” to “joy” between before and during or after the playback of a song, information indicating such change is stored in connection with the song. For example, if the user's smile or stress level changes from “0 to less than 30” to “30 to less than 70” between before and during or after playing a song, information indicating such change is stored in association with the song.

Here, the controller 23 may accumulate information indicating changes in the classification of emotions each time the song is delivered to one or more users, determine information indicating the influence that the song may have on human emotions (hereinafter referred to as “influence information”) using, for example, statistical methods, and store the information in the memory 22 in connection with the song. For example, if, for a predetermined number of users (e.g., 70% or more users) out of a plurality of users who have viewed a certain song, the classification of emotion changes from “sadness” to “joy” between before and during or after playback of the song, the controller 23 may store information indicating that the song changes human emotion from “sadness” to “joy” as The controller 23 may store information indicating that the song can change the human emotion from “sadness” to “joy” as “influence information” in the memory 22 by associating it with the song in question. For example, if, among a plurality of users who have viewed a certain song, the degree of smiling or stress changed from “0 to less than 30” to “30 to less than 70” between before and during or after playing the song, the controller 23 may store information indicating that the song may change the degree of smiling or stress from “0 The controller 23 may store information indicating that the song can change the degree of smile or stress from “0 to less than 30” to “30 to less than 70” as “influence information” in the memory 22 by associating it with the song.

Furthermore, the controller 23 may select one or more songs from a plurality of songs based on the classification of the user's emotions and the influence information associated with each song, and distribute them to said user. Specifically, controller 23 may obtain a classification of the user's emotions, similar to step S102 above. When the obtained classification is a predetermined first classification (e.g., “sadness”), the controller 23 may select and deliver to the user one or more songs to which influence information indicating that human emotions can be changed from the first classification to the predetermined second classification (e.g., “joy”) is associated. According to such a configuration, the user's emotional classification can be changed from the first classification to the second classification by playing the delivered song. Alternatively, the controller 23 may obtain the user's smile or degree of stress, etc., as a classification of the user's emotions. When the acquired degree is in the predetermined first range (e.g., “0 to less than 30”), the controller 23 may select and deliver to the user one or more songs to which influence information indicating that human emotions can change from the first range to the predetermined second range (e.g., “30 to less than 70”) is associated. According to such a configuration, the degree of the user's smile or stress, etc. can be changed from the first range to the second range by playing the delivered song.

In this disclosure, “song” refers to song consisting of sound source data such as vocals or instrumental performances, but is not limited to this. It can also be any song, such as music consisting of sound source data of so-called environmental sounds, such as the sound of flowing water, the sound of crowded places, or noise.

In the embodiment described above, the controller 23 of server 20 described an example of distributing the first song selected from the list of songs corresponding to the acquired classification of the user's emotion. In contrast, in other embodiments, the controller 23 may mix (blend) two sound source data to generate and deliver a single song based on the acquired classification of user emotion. For example, the controller 23 mixes the first sound source data and the second sound source data to generate one song based on the acquired classification of user emotion. Here, the “first sound source data” is the sound source data from vocal or instrumental performances, etc., and the “second sound source data” is the sound source data from environmental sounds. In detail, the controller 23 determines the volume and balance between the volume of the first sound source data and the volume of the second sound source data when mixing based on the acquired classification of user emotion. Here, any method can be employed to determine the volume balance based on the classification of the user's emotions. For example, the controller 23 may increase the volume of the second sound source data compared to the first sound source data when the acquired classification of user emotion is the predetermined first classification (e.g., “sadness”). The controller 23 may also reduce the volume of the second sound source data compared to the first sound source data when the acquired classification of the user's emotion is the predetermined second classification (e.g., “joy”). Alternatively, the controller 23 may increase the volume of the second sound source data compared to the first sound source data when the acquired user stress level is in the predetermined first range (e.g., “between 70 and 100”). The controller 23 may also reduce the volume of the second sound source data compared to the first sound source data when the acquired degree of user stress is in the predetermined second range (e.g., “0 to less than 30”).

For example, an embodiment in which a general purpose computer functions as the server 20 according to the above embodiment can also be implemented. Specifically, a program in which processes for realizing the functions of the server 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

### REFERENCE SIGNS LIST

1 music distribution system
10 terminal apparatus
11 communication interface
12 imager
13 output interface
14 input interface
15 memory
16 controller
20 server
21 communication interface
22 memory
23 controller
30 network

1. A music distribution system comprising a plurality of terminal apparatus each used by a plurality of users and a server configured to communicate with the plurality of terminal apparatus, wherein
the server is configured to store in its memory a plurality of song lists each corresponding to a plurality of classifications of human emotions,
each terminal apparatus is configured to generate a user image by photographing a user of its own apparatus,
the server is configured to acquire, for each terminal apparatus, a classification of a user's emotion estimated from the user image to select a song in the song list corresponding to the classification as a first song, and
each terminal apparatus is configured to play the first song selected for its own apparatus.

2. The music distribution system according to claim 1, wherein
each terminal apparatus is configured to obtain a user's evaluation of the first song during or after playing the first song, and
the server is configured to exclude, based on one or more user's evaluation of a first song selected for a certain song list, the first song from the song list.

3. The music distribution system according to claim 1, wherein
the server is configured to select, for each terminal apparatus, as a second song a song that is not included in said song list corresponding to said estimated classification,
each terminal apparatus is configured to play the second song selected for its own apparatus and obtain a user's evaluation of the second song during or after playing the second song, and
the server is configured to add, based on one or more user's evaluation of a second song selected for a certain song list, the second song to the song list.

4. The music distribution system according to claim 1, wherein
the server is configured to store an attribute of each song included in each song list in the memory,
each terminal apparatus is configured to obtain an attribute of the user, and
the server is configured to select, for each terminal apparatus, a song that is included in the song list corresponding to the estimated classification and that has the same or corresponding attribute as the user, as the first song.

5. The music distribution system according to claim 1, wherein the server is configured to obtain, when a playback of song is completed on a terminal apparatus, playback time of the song, and grant a reward according to the playback time to a rights holder of the song.

6. A music distribution system according to claim 1, wherein each song list includes at least one of the following: a song recorded performed by a musical instrument whose standard pitch is tuned to 432 Hz or 440 Hz, and a song recorded performed by a musical instrument whose pitch of at least one note in a scale is tuned to a solfeggio frequency.

7. A program configured to cause a server capable of communicating with a plurality of terminal apparatus used respectively by a plurality of users to execute operations, the operations comprising:
storing in its memory a plurality of song lists corresponding respectively to a plurality of classifications of human emotions;
acquiring, for each terminal apparatus, a classification of a user's emotion estimated from a user image generated by the terminal apparatus by photographing a user of its own apparatus to select a song in the song list corresponding to the classification as a first song; and
distributing, for each terminal apparatus, the first song to the terminal apparatus.

8. A server comprising:
a communication interface configured to communicate with a plurality of terminal apparatus each used by a plurality of users;
a memory configured to store a plurality of song lists each corresponding to a plurality of classifications of human emotions; and
a controller configured to acquire, for each terminal apparatus, a classification of a user's emotion estimated from a user image generated by the terminal apparatus by photographing a user of its own apparatus to select a song in the song list corresponding to the classification as a first song, and distribute the first song to the terminal apparatus.
